(19) United States
(12) Patent Application Publication
(10) Pub. No.: US 2007/0011172 A1
(43) Pub. Date: Jan. 11, 2007

(54) Managed e-community trading environments

(75) Inventor: George Eino Ruul, Applecross (AU)

Correspondence Address: CARR & FERRELL LLP, 2200 GENG ROAD, PALO ALTO, CA, 94303, US

(73) Assignee: NetFire1 Pty Ltd

(21) Appl. No.: 11/251,316

(22) Filed: Oct. 14, 2005

Related U.S. Application Data
(60) Provisional application No. 60/696,997, filed on Jul. 5, 2005.

(51) Int. Cl. G06Q 30/00; G06F 17/30

(52) U.S. Cl. 707/10; 705/26

(57) ABSTRACT

Exemplary systems and methods for managed e-community trading environments are provided. The system comprises one or more networked users; an e-community administrator configured to monitor the users; and an e-community server configured to allow the users to interact over the network. Exemplary methods of the present invention include establishing a network user as an e-community administrator; the e-community administrator determining a log-in and password or registration process for the e-community and allowing members to join the e-community and interact with other e-community members. Other embodiments of the method include authenticating the members of the e-community, monitoring at least some of the members' communications over the e-community, and performing product queries.

### CROSS REFERENCE TO RELATED APPLICATION

The present application claims the benefit and priority of Provisional Patent Application Ser. No. 60/696,997, filed Jul. 5, 2005 and entitled “System and Method for Optimized E-Commerce Trading,” which is incorporated herein by reference. The present application is also related to U.S. patent application Ser. No. 11/214,515 filed Aug. 29, 2005 for “Managed E-Commerce Trading,” also incorporated herein by reference.

### BACKGROUND OF THE INVENTION

1. Field of the Invention

The present invention relates generally to e-commerce, and more particularly to e-community trading environments.

2. Description of Related Art

The Internet has developed into a dominate force in the global business market and the global exchange of ideas and information. The result has been an explosion in websites scattered across the Internet landscape. These websites address an infinite variety of interests, but are not held together by any underlying infrastructure. Additionally, many of these websites can only be found by Internet users via one or more Internet search engines. Once a website is identified, Internet users have to further search the individual website for the information or products they seek. Oftentimes, this consumes countless time spent combing through outdated information. Once the desired information or product is located, the Internet user must risk disclosure of private information to unknown and unverified third parties in order to obtain additional information or purchase a product. The result is that Internet users are left without an efficient way of identifying relevant, trustworthy, and current Internet websites and users for the exchange of information and products. Accordingly, there is a need for a system and method for managed e-community trading environments.

### SUMMARY

The present invention provides exemplary systems and methods for managed e-community trading environments. The exemplary system comprises one or more e-community members, an e-community administrator configured to monitor the e-community, and an e-community server configured to allow the e-community members to interact over a network. Other embodiments of the system comprise the e-community administrator monitoring the e-community members' communications. Further embodiments comprise an e-community server with an authentication module configured to authenticate e-community members.

Exemplary methods of the present invention include establishing a network user as an e-community administrator, the e-community administrator determining a log-in and password for the e-community and distributing the log-in and password to prospective e-community members, and members joining the e-community and interacting with each other. Other embodiments include the e-community. administrator monitoring at least some of the members' communications over the e-community. Further embodiments of the method include authenticating the members of the e-community.

### BRIEF DESCRIPTION OF THE DRAWINGS

FIG. 1 is a simplified architecture of an exemplary e-community;

FIG. 2 is an exemplary e-community architecture in which various embodiments of the present invention may be practiced;

FIG. 3 is an exemplary e-community server according to one embodiment;

FIG. 4 shows an exemplary scenario of a direct search by an e-community member;

FIG. 5 shows an exemplary scenario of an indirect search by an e-community member;

FIG. 6 shows an exemplary table of search results as provided to e-community members according to some embodiments; and

FIG. 7 shows a flowchart for an exemplary method for the establishment of an e-community according to some embodiments.

### DESCRIPTION OF EXEMPLARY EMBODIMENTS

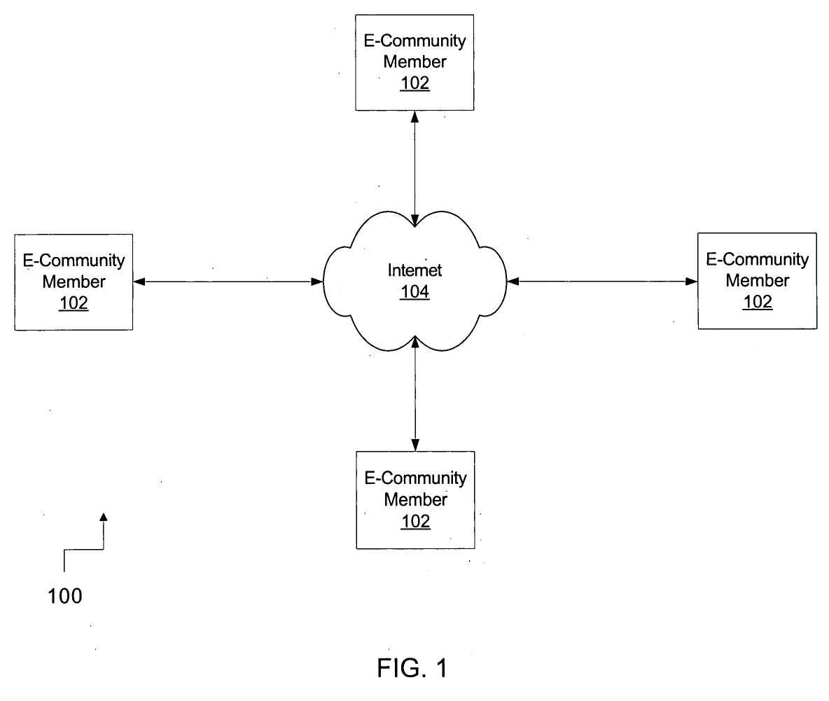

Referring to FIG. 1, a simplified architecture of an exemplary e-community 100 is shown. An e-community 100 is a collection of computerized device users or members 102 connected to a network and who share a common interest. In FIG. 1, the members 102 are connected to the Internet 104. The number of possible e-communities 100 that can be formed is limited by only the number of shared interests that can exist in a population of computerized device users. The population of computerized device users is growing daily and is comprised of desktop computer users, laptop computer users, PDA users, cell phone or other thin device users, and the users of other computerized devices with networking capability. E-communities 100 can be based on such shared interests as hobbies, geographic regions, academic interests, religion, heritage, culture, history, current events, and commercial goods and services.

An e-community 100 may be a public e-community where any user may join and become a member 102. Alternatively an e-community 100 may be a private e-community in which only selected users can join. For example, the public e-community 100 may be a stamp collecting community comprising stamp collectors 102 and/or stamp sellers 102. Likewise, the private e-community 100 may be a community of the owners of a particular hamburger franchise 102 that wish to exchange inventory and information pertinent to the operation of that particular hamburger franchise. In some embodiments, membership in the private e-community 100 may be by invitation only. The members 102 may comprise individuals, businesses (i.e., vendors), or any other entity with an interest in the e-community 100.

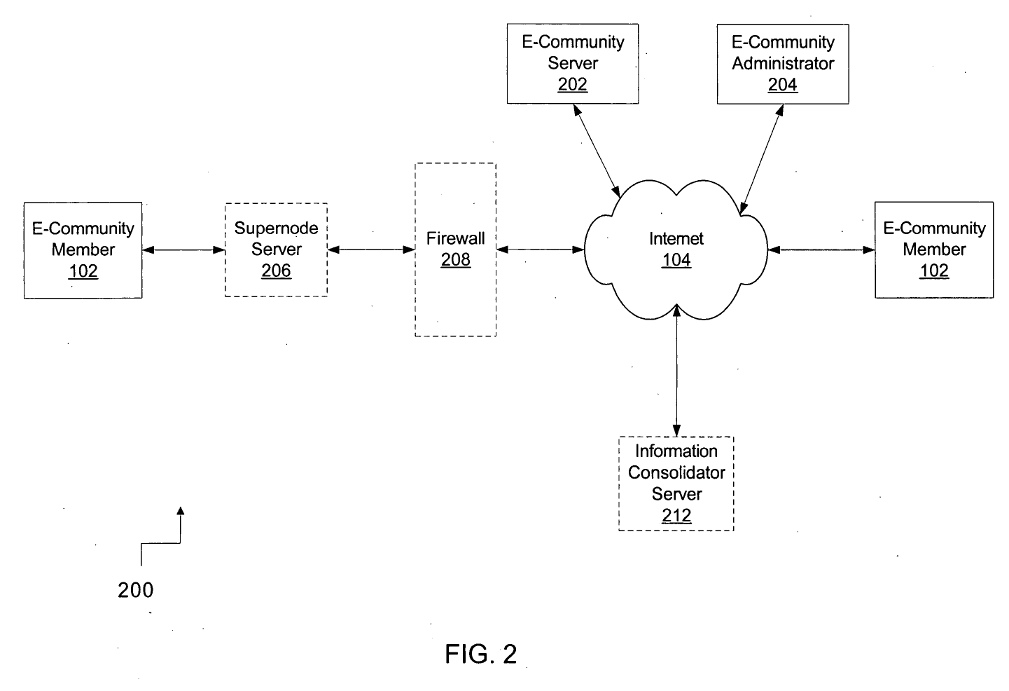

FIG. 2 shows an exemplary e-community architecture 200 in which the present invention may be practiced. The architecture 200 comprises various e-community components, including an e-community server 202 and a plurality of e-community members 102. The e-community server 202 may also be an e-commerce server. The e-community architecture 200 may further comprise an e-community administrator 204. An optional supernode server 206, firewall 208, and information consolidator server 212 may also be provided in the e-community architecture 200.

The e-community administrator 204 is responsible for management of the particular e-community 100 (FIG. 1). In one embodiment, all members 102 of the e-community 100 are registered with the e-community administrator 204 in order to access other members of the e-community 100 and/or to receive e-community communications. For example, a monthly newsletter may be sent to e-community members 102.

In some embodiments of the present invention, the e-community administrator 204 receives some or all of the copies of communications (i.e., data packets) sent between the various members 102 of the e-community 100. In some embodiments, the copies are routed to the e-community administrator 204 for storage. The e-community administrator 204 may then monitor the communications. For example, the administrator 204 can check for spam. Thus in the example of a stamp collecting e-community 100 (FIG. 1), if a communication offering diet pills is detected by the e-community administrator 204, the e-community administrator 204 can remove the communication before the communication is sent to some or all of the members 102 of the stamp collecting e-community 100.

In a further embodiment, the e-community administrator 204 may selectively monitor communications in the e-community 100. For example, a long-time member 102 may not have his communications monitored, but the communications of a new member 102 may be monitored to ensure proper usage of the e-community 100. In various embodiments, the e-community administrator 204 is the e-community server 202.

According to some embodiments, when an e-community member 102 is located behind the firewall 208, the supernode server 206 may be utilized. Specifically, the supernode server 206 allows the e-community member 102 to communicate through the firewall 208 by directing network traffic through a standard HTTP port (e.g., Port 80). These supernode servers 206 may be deployed within specific trading e-communities 100 (e.g., privately established set of sellers) or in a common central pool. Thus, the system is scalable for each e-community 100.

In exemplary embodiments, a specialized GUID-over-IP transport mechanism allows e-communities 100 to be coupled through a network of internal and external routers, proxies, and firewalls 208 without requiring reconfiguration of the various communications equipment. Routing management allows for control over pathways taken by communicating entities, thus allowing for monitoring to be implemented. This may be an important feature for sensitive e-communities 100 where enhanced security might be important. Additionally, load balancing and N-tier construction allow for efficient scale out rather than scale up implementations.

Additionally, a non-repudiation protocol may be utilized to insure integrity in the system. For example, origin of data exchanged over the architecture 200 is known and tracked. In one embodiment, electronic certificates may be utilized to guarantee that communications are delivered only to the intended recipient(s), that the transmission is secure, and that the identity of the member 102 is controlled. Timestamps and encryption keys may also be a part of the non-repudiation protocol. AS2 (Applicability Statement 2) secure transport protocol may, in some embodiments, be utilized to provide the non-repudiation protocol.

In a further embodiment, a payment gateway may be coupled to the e-community architecture of FIG. 2. The payment gateway adds a financial tie-in (e.g., relationship with financial institutions) to insure payment for any transaction.

It should be noted that the architecture 200 of FIG. 2 is exemplary. Alternative embodiments may comprise more or fewer components. For example, more than one information consolidator server 212 or e-community server 202 may be provided. Furthermore, any number of e-community members 102 may be present on the system.

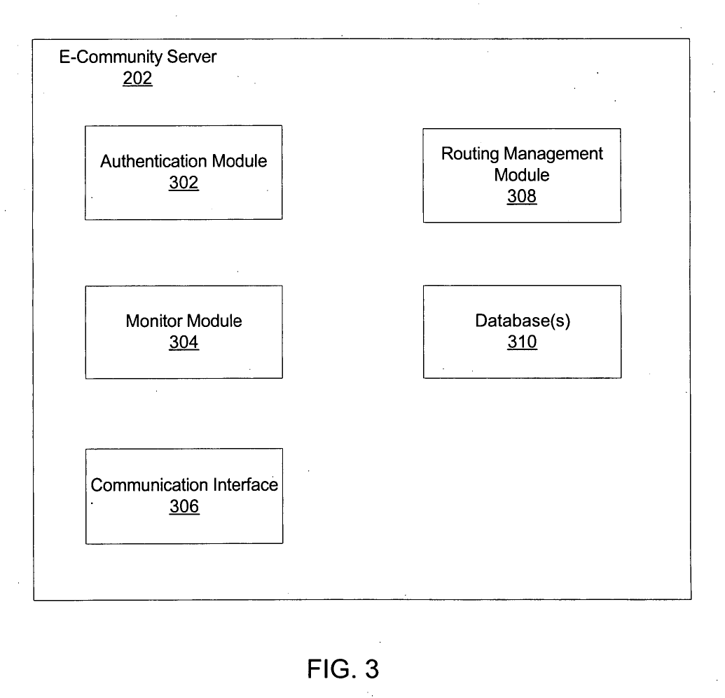

Referring to FIG. 3, the exemplary e-community server 202 is shown in more detail. In exemplary embodiments, the e-community server 202 comprises an authentication module 302, a monitor module 304, a communication interface 306, a routing management module 308, and at least one database 310. In further embodiments, the database 310 may comprise a plurality of databases, each storing designated data. For example, the e-community server 202 may comprise an authentication database (e.g., containing member information), a monitor database (e.g., storing transaction information), and an e-community database (e.g., storing various e-community and e-commerce plug-ins and modules that may be accessed and downloaded onto member 102 (FIG. 2) devices). In yet a further embodiment, the e-community server 202 is coupled. to the database(s) 310 which are located outside of the e-community server 202.

The exemplary authentication module 302 authenticates members 102 and their respective e-communities 100 (FIG. 1). When a user first registers with the e-community server 202, the user provides user data such as user name, password, and contact information. This information is then stored into the database 310. Authentication may occur seamlessly and unobtrusively to the member 102. In one embodiment, the authentication process may comprise verifying member 102 names and passwords stored in the database 310. Alternative methods for authenticating members 102 may be utilized, such as verifying IP addresses in communications sent between the members 102 within the e-communities 100 versus addresses stored in the database 310.

Regardless of the authentication method, the e-community server 202 will receive authentication information from the members 102 via the communication interface 306. The authentication module 302 then compares the received authentication information to authentication information stored in the database 310. Therefore, any member 102 accessing or utilizing a particular e-community 100 is known to the particular e-community and, based on the specific permissions associated with the member 102, the member may be enabled to interact with other specified e-communities 100 and its respective members 102. The authentication may occur during an initial connection with the system (e.g., login at a start of a session). In alternative embodiments, authentication may occur at times other then initial connection, such as when a purchase transaction occurs.

In a further embodiment, the e-community server 202 receives copies of some or all communications or packets sent between members 102. According to some embodiments, the monitor module 304 monitors communications between e-community members 102 via these packet copies. By monitoring communications, integrity of the e-community 100 may be insured. In one embodiment, the packet copies are received by the communication interface 306 and stored into the database 310. The monitor module 304 may then review the stored packet copies at any time. Alternatively, the packet copies may be reviewed prior to storing on the database 310.

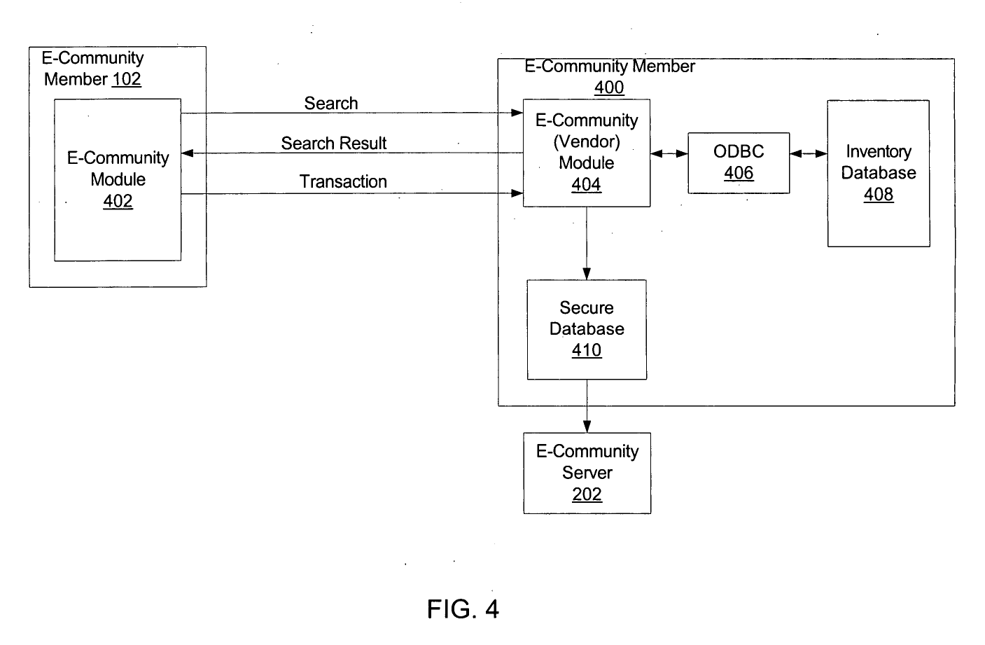

Referring to FIG. 4, an exemplary scenario of a direct search by an e-community member 102 is shown. In this particular search, the e-community member 102 is a baseball card collector in search of a rookie year baseball card for Willie Mays. The e-community member 102 may be a user on a computer, a mobile phone (i.e., a thin client), or any other wired or wireless computing device that allows for searching via the Internet 104 (FIG. 1). In exemplary embodiments, the computing device of the member 102 has an e-community module 402 downloaded (from the e-community server 202 of FIGS. 2-3) and installed thereon.

The e-community module 402 seamlessly integrates into the computing device of the member 102. The exemplary e-community module 402 may comprise a specialized browser technology optimized for e-community communication using the Internet 104 without depending on existing HTML/XML browser technology. In a further embodiment, the e-community module 402 allows the member 102 to set-up favorite groups of e-communities 100 (FIG. 1) that can be searched. The e-community module 402 also allows a member 102 to customize other search options and perform other customization features.

In this scenario, the owner of the rookie year baseball card for Willie Mays is a vendor member 400 of an e-community 100 dedicated to baseball card collecting. The vendor member 400 may be an individual member, a business, or any other entity having an affiliation to the e-community 100. This vendor member 400 has a corresponding e-community (vendor) module 404. In this scenario, when the e-community vendor member 400 registered with the e-community server 202 (FIG. 2), the e-community (vendor) module 404 was downloaded and installed from the e-community server 202 onto the corresponding computing device. As with the e-community module 402, e-community (vendor) module 404 may allow direct access into a database, and in some embodiments, comprise the same e-community module functionalities. In this scenario, the database is an inventory database 408 that contains a listing of every baseball card available for trading as owned by e-community vendor member 400. Embodiments of the present invention eliminate the need for a central database and instead forward the query to the available vendor members 400 to execute a real-time search of any relevant and available database. For example, in this scenario, back end integration with legacy products utilizing plug-ins of the e-community (vendor) module 404 allows the searching member 102 direct access to the inventory database 408 of the e-community vendor member 400.

In the present embodiment, the searching member 102 has direct access to and communicates with the vendor member 400. Thus, the search query is sent directly to the e-community (vendor) module 404. The search query may comprise a search using other criteria such as product codes, (whole, part, or sectional) product descriptions, part numbers, or any other flexible search criteria. According to some embodiments, a member 102 may select criteria from a (real or virtual) catalog or menu. In yet further embodiments, the search query may be from a bill of materials or any XML list. For example, a member 102 might create a list of baseball cards they wish to locate and/or trade and encapsulate that list with XML tags (which may include a list of other members 102 to query), and forward this list to other e-community members 102 & 400. In alternative embodiments, non-XML tags may be utilized. Advantageously, this embodiment allows individuals who may not have a website to list their products.

The e-community (vendor) module 404 receives the query and, via an open database connection (ODBC) 406, the inventory database 408 of baseball cards available for trading is searched for the requested information. The inventory database 408 is, in exemplary embodiments, the internal database utilized by the vendor member 400 for maintaining an inventory of the baseball cards available for trading. Because the searching member 102 can directly query the inventory database 408 of baseball cards available for trading, the baseball card data is the most current data available and there is no need for a centralized database with “pushed” information. The requested information is then sent back via the e-community vendor module 404 to the searching e-community module 402. If the searching member 102 decides to make an offer to the vendor member 400 for the Willie Mays rookie year baseball card, a purchase/trade request communication is sent by the searching member 102.

In exemplary embodiments, copies of the communications between members 102 & 400 are made by the e-community (vendor) module 404. Alternatively, the e-commerce module 402 may make the copies. The copies are then sent to the e-community server 202 (FIG. 2) in real time. Alternatively, the copies may be stored in a secure database 410. The secure database 410 may be at the site of either member 102 or 400. Then at a predetermined time or when a predetermined number of copies are stored, the copies are forwarded to the e-community server 202 or the e-community administrator 204 (FIG. 2). Alternatively at predetermined times, the e-community server 202 or e-community administrator 204 retrieves the information from the secure database. In yet further embodiments, not all communications are copied. For example, the e-community (vendor) module 404 may only copy communications involving a purchase or trade transaction. While the example of FIG. 4 shows one e-community member 102 directly searching one e-community member 400, embodiments of the present invention allow one or more e-community members 102 to directly search one or more e-community vendor members 400 at a substantially simultaneous time.

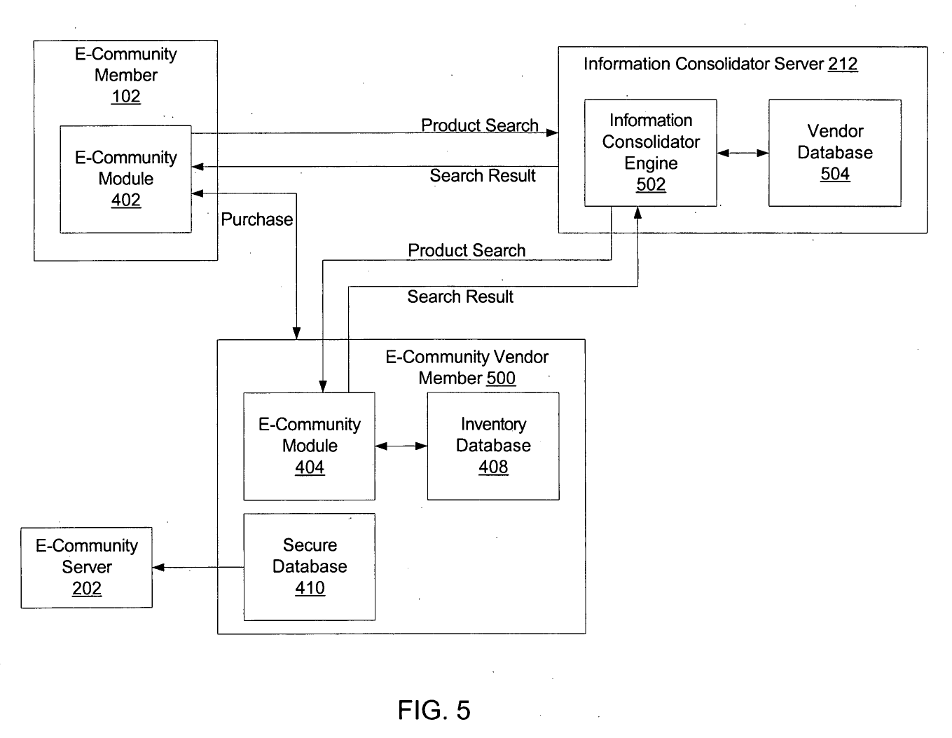

Referring to FIG. 5, an exemplary scenario of an indirect product search between an e-community member 102 and an e-community vendor member 500 is shown. In the indirect search scenario, the queries and responses are directed through the information consolidator server 212. Thus in the present embodiment, a product search query is first forwarded to the information consolidator server 212 having an information consolidator engine 502. The product search query may comprise a search using product codes, (whole, part, or sectional) product descriptions, part numbers, or any other flexible search criteria. Alternatively, the e-community member 102 may select a product from a (real or virtual) catalog. In yet further embodiments, the product search query may be from a bill of materials or any XML list. In alternative embodiments, non-XML tags may be utilized.

Upon receiving the product search, the information consolidator engine 502 checks a coupled e-community vendor member database 504 to determine qualified e-community vendors to forward the query. Although only one e-community vendor member database 504 is shown, alternative embodiments may comprise any number of e-community vendor member databases 504.

Once the one or more proper e-community vendor members 500 are identified, the product search is forwarded to each e-community vendor member 500. In exemplary embodiments, the e-community vendor member 500 is enabled, by having downloaded and installed the e-community module 404 to its Internet coupled computing device. A business profile of the e-community vendor member 500 including name and address information may be stored in the e-community vendor member database 504 and used to determine search query access (i.e., where a product search query should be sent). Other information including descriptions for business attributes may be optionally provided to the e-community vendor member database 504. The business profile is then stored in the e-community vendor member database 504. The business profile may also be stored at the e-community server 202 during the downloading and/or installation of the e-community (vendor) module 404.

The product search query is forwarded to the e-community module 404 at the e-community member vendor 102 site. The e-community module 404 checks a coupled inventory database 408 to determine inventory and pricing information based on the product search. In exemplary embodiments, the inventory database 408 is the same internal, inventory database maintained by the e-community vendor member 500, thus eliminating the need to copy inventory information to a searchable database. In exemplary embodiments, a keyword search may be performed on metadata, actual inventory, or both.

The search result is then sent to the e-community member 102 via the information consolidator server 212. For example, if the product search query comprises a XML list, then the result may be returned to the e-community member 102 and displayed in a XML format. Advantageously, the present invention allows the e-community member 102 to execute complex search queries with minimal effort and maximum results. In an alternative embodiment, the search result may be sent directly to the e-community member 102 without having to traverse through the information consolidator server 212. The result may be displayed based on any preferences set by the e-community member 102.

Should the e-community member 102 decide to purchase the product, the e-community member 102, in one embodiment, establishes a link with the e-community vendor member 500 and proceeds with purchase of the product(s) directly from the e-community vendor member 500. This eliminates the need for middle-men and allows small vendors without websites to reach a large number of prospective customers. While the example of FIG. 5 shows one e-community member 102 directly searching one e-community vendor member 500, embodiments of the present invention allow one or more e-community members 102 to directly search one or more e-community member vendors 500 at a substantially simultaneous time.

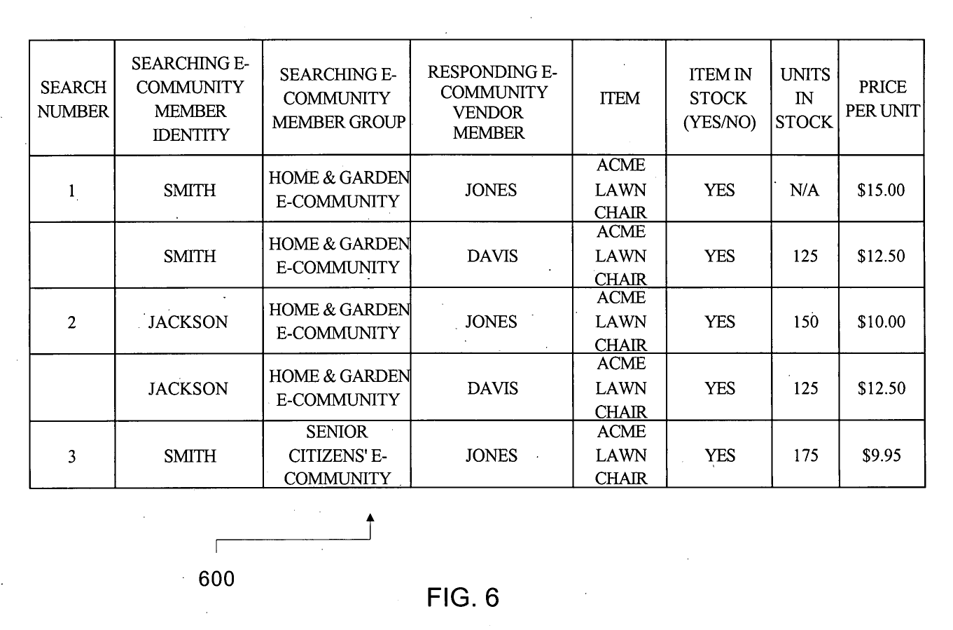

Referring to FIG. 6, an exemplary table 600 of search results as provided to e-community members 102 (FIG. 2) according to various embodiments is shown. In connection with search scenarios such as those shown and described in connection with FIGS. 4 and 5 herein, a searching e-community member 102 will receive search results from one or more responding e-community vendor members 400 or 500 (FIGS. 4 and 5).

In further embodiments, the authentication module 302 (FIG. 3) or other similar component(s) checks the identity of the searching e-community member 102 and/or the identity of the e-community 100 (FIG. 1) in which the member 102 belongs. When a user first registers with the e-community server 202 (FIG. 2), the user provides user data such as user name, password, and contact information. This information is then stored into the database 310 (FIG. 3). Authentication may occur seamlessly and unobtrusively to the member 102. In one embodiment, the authentication process may comprise verifying member 102 names and passwords stored in the database 310. Alternative methods for authenticating members 102 may be utilized, such as verifying IP addresses in communications sent between the members 102 within the e-communities 100 versus addresses stored in the database 310.

The herein described authentication systems and methods result in the searching e-community member 102 receiving search results tailored to the searching e-community member's identity or e-community affiliation. This feature also allows a particular responding e-community vendor member 400 or 500 to discriminate on the basis of price, quantity, or other information provided to particular searching e-community members 102 based on the searching e-community member's identity or e-community affiliation, as described in the example below.

Table 600 in FIG. 6 illustrates exemplary search results provided to two different e-community members 102 based upon three separate searches for the same item. In search number 1, e-community member Smith is provided search results by responding e-community vendor members Jones and Davis. In search number 1, searching e-community member Smith indicates his affiliation as a member of the Home & Garden E-Community 100. In response, e-community vendor member Jones elects not to share inventory information with searching e-community member Smith, however, indicates to e-community member Smith that Acme Lawn Chairs are available from e-community member vendor Jones for $15.00 per chair. In search number 1, e-community vendor member Davis elects to share inventory information with searching e-community member Smith. E-community vendor member Davis indicates to searching e-community member Smith that 125 Acme Lawn Chairs are available for $12.50 per chair.

In search number 2, searching e-community member Jackson indicates his affiliation as a member of the Home & Garden E-Community. In response, responding e-community vendor member Jones elects to share inventory information with searching e-community member Jackson. E-community vendor member Jones indicates to searching e-community member Jackson that 150 Acme Lawn Chairs are available for $10.00 per chair. Although this result varies from the result Smith received from Jones under similar circumstances in connection with search number 1, other factors influence the favorable terms received by Jackson from Jones. For example, Jackson could have a previous business relationship with Jones (which is stored in a profile). Alternatively, other elements of Jackson's profile may play a factor (e.g., Jackson is a retailer and is granted a retailer discount, Jackson is a repeat customer, or Jackson is a large quantity buyer). These profiles may be stored in the database 310 of the e-community server 202, for example. In search number 2, e-community vendor member Davis elects to share inventory information with searching e-community member Jackson. E-community vendor member Davis indicates to e-community member Jackson that 125 Acme Lawn Chairs are available for $12.50 per chair.

In search number 3, searching e-community member Smith changes the affiliation to reflect an affiliation as a member of the Senior Citizens' E-Community 100. In response, responding e-community vendor member Jones elects to share inventory information with searching e-community member Smith. Responding e-community vendor member Jones indicates to searching e-community member Smith that 175 Acme Lawn Chairs are available for $9.95 per chair. In search number 3, Davis is not a member of the senior citizens' e-community, and thus is not allowed to trade with Smith.

In further embodiments, members 102, 400 and/or 500 of a particular e-community 100 can communicate or push certain information relevant to the e-community's shared interest to some or all of the e-community's membership. Utilizing the herein described authentication systems and methods, an e-community member 102, 400 and/or 500 can target those members of the e-community 100 in which to receive notice of a special event, sale, or similar occurrence. Such communication can take the form of a pop-up message or email delivered to the targeted recipients. For example, a member 102 of a baseball e-community 100 can communicate or push information concerning recently released World Series tickets to other members of the baseball e-community 100. Alternatively, a member 102 of a wildlife conservation e-community 100 can communicate or push information about an upcoming lecture on bird watching to other members of the wildlife conservation e-community 100. In the event such communicated or pushed information concerns the possible transaction of goods or services, e-community members 102 can rely on the systems and methods described herein for secure and reliable transactions between e-community members 102, 400 and/or 500.

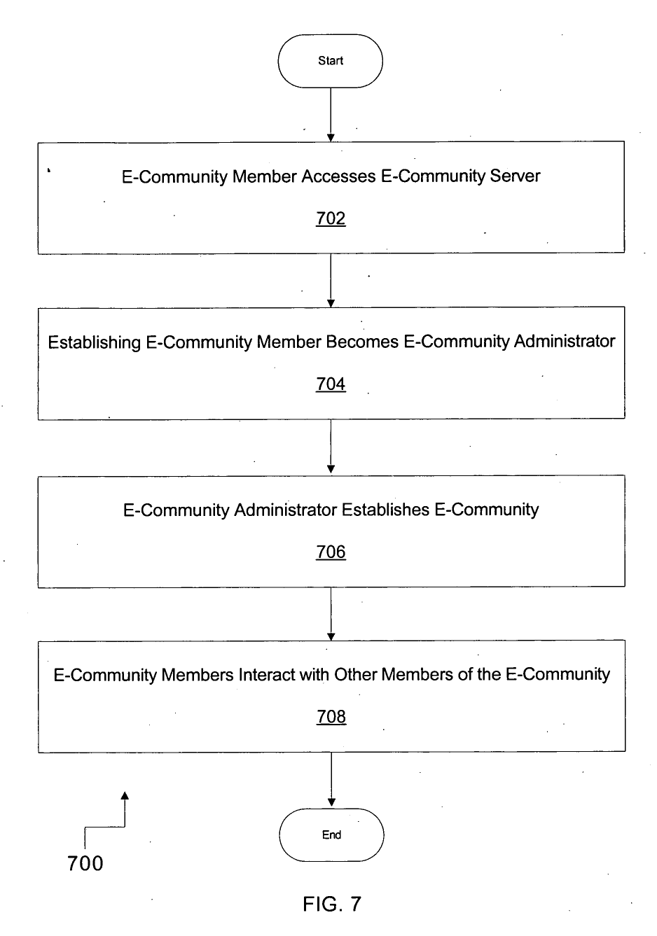

Referring to FIG. 7, establishment of an exemplary e-community 100 (FIG. 1) is shown. An e-community 100 may be a public e-community where any user may join and become a member 102 (FIG. 1). Alternatively, an e-community 100 may be a private e-community in which only selected users can join.

At step 702, a member 102 establishes an e-community 100 by accessing an e-community server 202 (FIG. 2) and requesting to set-up a new e-community.

At step 704, the establishing member 102 functions as the e-community administrator 204 (FIG. 2), according to various embodiments. The e-community administrator 204 is responsible for the management of the particular e-community 100. In one embodiment, all members 102 of the e-community 100 register with the e-community administrator 204 in order to access other members of the e-community 100 and/or to receive e-community communications. For example, a monthly newsletter may be sent to e-community members 102. Alternatively, registration may occur via the e-community server 202.

At step 706, the e-community administrator 204 establishes the e-community 100. In one embodiment, the e-community administrator 204 may set-up an e-community log-in and password, which is given to e-community members. Alternatively, the e-community administrator 204 may set up a registration process for new members of the e-community. In one embodiment, the new members can select their own login and password for accessing the e-community. Additionally, the members may set up a profile which can be used to customize their membership experience. When a new member registers, they may also download an e-community module 402 (FIG. 4) or e-community vendor module 404 (FIG. 4) if they do not already have the modules 402 and 404.

At step 708, e-community members 102 interact as described herein and shown in FIGS. 4-6.

The present invention is described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

What is claimed is:

1. An e-community system comprising:
an e-community administrator configured to monitor one or more members of an e-community; and
an e-community server configured to allow the one or more members to interact within the e-community.

2. The system of claim 1 wherein the e-community administrator is further configured to monitor communications of the one or more members.

3. The system of claim 1 wherein the e-community server comprises an authentication module configured to authenticate the one or more members.

4. The system of claim 1 wherein the e-community administrator is the e-community server.

5. The system of claim 1 wherein the e-community server is further configured to establish a new e-community.

6. The system of claim 1 further comprising a supernode server configured to allow the one or more members to communicate with the network through a firewall.

7. The system of claim 1 wherein the e-community server is further configured to provide an e-community module to the one or more members.

8. The system of claim 7 wherein the e-community module allows the one or more e-community members to operate in the e-community.

9. The system of claim 7 wherein the e-community module is further configured to perform a direct product query of an inventory database of at least one member.

10. The system of claim 1 wherein one member of the e-community may push a communication to the one or more members.

11. The system of claim 1 further comprising an information consolidator server configured to query an inventory database.

12. A method for establishing an e-community comprising:
accessing an e-community server;
establishing an e-community administrator for a new e-community; and
establishing a registration process for the new e-community.

13. The method of claim 12 further comprising the e-community administrator monitoring at least some of the e-community members' communications over the e-community.

14. The method of claim 12 further comprising authenticating the members of the e-community.

15. The method of claim 12 further comprising allowing new members to join an e-community via the registration process.

16. The method of claim 12 further comprising providing communications to members of the e-community.

17. The method of claim 16 wherein the communication is a pushed announcement from a member.

18. The method of claim 12 further comprising allowing product searches between members of the e-community.

19. A method for performing a product search within an e-community comprising:
logging into an e-community;
creating a product query to at least one vendor member; and
displaying results of the product query.

20. The method of claim 19 further comprising directly accessing an inventory database of the at least one vendor member.

21. The method of claim 19 wherein the results of the product query may differ based on a member profile.
